(19) United States
(12) Patent Application Publication
(10) Pub. No.: US 2025/0123401 A1
(43) Pub. Date: Apr. 17, 2025

(54) APPARATUS AND METHOD FOR IDENTIFYING POSITION OF MOVING OBJECT ON BASIS OF GNSS AND NOTIFYING OF DANGEROUS ACCIDENTS

(71) Applicant: HANWHA CORPORATION, Seoul (KR)

(72) Inventors: Seung Won SEO, Seongnam-si (KR); Prasetiyo Radius BHAYU, Seongnam-si (KR)

(21) Appl. No.: 18/915,851

(22) Filed: Oct. 15, 2024

(30) Foreign Application Priority Data
Oct. 16, 2023 (KR) 10-2023-0137584

(51) Int. Cl. G01S 19/07

(52) U.S. Cl. CPC G01S 19/07

(57) ABSTRACT

Proposed is an apparatus and method for identifying a position of a moving object on the basis of the Global Navigation Satellite System (GNSS) and notifying of dangerous accidents. The apparatus includes a GNSS position information data receiving unit receiving current position information data of a mobile device by receiving each GNSS position signal from a plurality of GNSS satellites, a Radio Technical Commission for Maritime Services (RTCM) position correction data receiving unit receiving position correction data of the mobile device in the form of an RTCM stream through a Network Transport of RTCM via Internet Protocol (NTRIP), a precision position data acquisition unit acquiring precision position data of the mobile device, and a diagram display unit displaying the acquired precision position data of the mobile device, a position of another mobile device positioned within a predetermined range, a work section, and a danger area on a diagram.

### CROSS REFERENCE TO RELATED APPLICATION

The present application claims priority to Korean Patent Application No. 10-2023-0137584, filed Oct. 16, 2023, the entire contents of which are incorporated herein for all purposes by this reference.

### BACKGROUND OF THE INVENTION

### Field of the Invention

The present disclosure relates to an apparatus and method for identifying a position of a moving object on the basis of the Global Navigation Satellite System (GNSS) and notifying of dangerous accidents. More particularly, the present disclosure relates to an apparatus and method for identifying a position of a moving object on the basis of the GNSS, the apparatus and method being configured to acquire precision position data of a mobile device by applying position correction data to current position information data, and the apparatus and method being configured to generate and output danger notification information on a screen of the mobile device when at least one of a distance between the measured precision position data of a mobile device and another mobile device positioned within a predetermined range, a distance between the precision position data of the mobile device and a work section, and a distance between the precision position data of the mobile device and a danger area is included in a predetermined danger range.

### Description of the Related Art

Generally, a position calculated by using a Global Navigation Satellite System (GNSS) receiver is expressed in three dimensions consisting of two-dimensional plane coordinates and altitude.

The position calculated by using the GNSS receiver is expressed as a three-dimensional (x, y, and z) coordinate consisting of plane coordinates and altitude. In the position calculated solely by the GNSS receiver, the accuracy of the calculated position may have an error of up to 15 m due to a system error that occurs between GNSS observations, an accidental error, and so on.

In order to calculate an accurate position with the GNSS receiver, a Differential GNSS (DGNSS) method or a Real Time Kinematic (RTK) method is used. Through this result, the GNSS receiver may acquire position information of the meter-level accuracy or the centimeter-level accuracy.

Meanwhile, due to the remarkable development of mobile devices, smartphones and tablet PCs are provided with small GPS receiving chips (circuits) embedded therein, so that a position information service capable of displaying coordinate information about a current position thereof on a corresponding data file created by cadastral surveying is capable of being realized.

Smartphones and tablet PCs operate with a plurality of embedded programs (S/W), and among the programs, there is a growing trend of developing applications, applets, or apps (APPLs or APPs) having relatively small data and relatively small step so as to realize various functions.

In addition, since smartphones and tablet PCs have an internet access function, the smartphones and the tablet Pcs are capable of compose position information including test, photos, images, cadastral boundary points, and boundary lines to file type position information, are capable of converting the file type position information into a map format in various types, and are capable of transmitting the map format in real time.

However, as mobile devices such as smartphones have been introduced, applications related to geographic information have been developed. There is a need for directly inputting and editing graphic data and databases in the field and expressing the current position by using the GNSS so as to minimize positional errors and survey inaccuracies and also to simplify a process of constructing large geographic information data and to improve accuracy so that survey maps are created more quickly and accurately and the created data and the survey maps are provided and stored.

In this regard, in Korean Patent No. 10-2022-0017264, there is provided a “METHOD AND APPARATUS OF UPDATING POSITION OF MOVING OBJECT BASED ON GNSS”.

### SUMMARY OF THE INVENTION

Accordingly, the present disclosure has been made keeping in mind the above problems occurring in the related art, and an objective of the present disclosure is to provide an apparatus and method for identifying a position of a moving object on the basis of the Global Navigation Satellite System (GNSS) and notifying of dangerous accidents, the apparatus and method being configured to receive current position information data of a mobile device attached to a drilling apparatus and position correction data of the mobile device by receiving by receiving each GNSS position signal from a plurality of GNSS satellites, and the position correction data being repeatedly generated by a plurality of reference stations for each GPS satellite.

In addition, another objective of the present disclosure is to provide an apparatus and method for identifying a position of a moving object on the basis of the GNSS and notifying of dangerous accidents, the apparatus and method being configured to measure a distance between acquired precision position data of a mobile device and a position of another mobile device positioned within a predetermined range, a distance between the acquired precision position data of the mobile device and a work section, and a distance between the acquired precision position data of the mobile device and a danger area.

In addition, still another objective of the present disclosure is to provide an apparatus and method for identifying a position of a moving object on the basis of the GNSS and notifying of dangerous accidents, the apparatus and method being configured to generate and output danger notification information on a screen of a mobile device when at least one of a distance between measured precision position data of a mobile device and another mobile device positioned within a predetermined range, a distance between the precision position data of the mobile device and a work section, and a distance between the precision position data of the mobile device and a danger area is included in a predetermined danger range.

In order to achieve the objectives described above, according to the present disclosure, there is provided an apparatus for identifying a position of a moving object on the basis of the Global Navigation Satellite System (GNSS) and notifying of dangerous accidents, the apparatus including: a GNSS position information data receiving unit configured to receive current position information data of a mobile device by receiving each GNSS position signal from a plurality of GNSS satellites; a Radio Technical Commission for Maritime Services (RTCM) position correction data receiving unit configured to receive position correction data of the mobile device in the form of an RTCM stream through a Network Transport of RTCM via Internet Protocol (NTRIP), the position correction data being repeatedly generated by a plurality of reference stations for each GPS satellite; a precision position data acquisition unit configured to acquire precision position data of the mobile device by applying the position correction data to the received current position information data; and a diagram display unit configured to display the acquired precision position data of the mobile device, a position of another mobile device positioned within a predetermined range, a work section, and a danger area on a diagram that is pre-stored and activated on a screen of the mobile device.

In addition, the mobile device may be at least one of a terminal attached to a work vehicle and a terminal carried by a worker.

In addition, the apparatus may further include a precision position data receiving unit configured to receive precision position data acquired from another mobile device in real time.

In addition, the apparatus may further include a distance measurement unit configured to measure a distance between the acquired precision position data of the mobile device and the position of another mobile device positioned within the predetermined range, a distance between the acquired precision position data of the mobile device and the work section, and a distance between the acquired precision position data of the mobile device and the danger area.

In addition, the apparatus may further include a danger notification providing unit configured to generate and output danger notification information on the screen of the mobile device when at least one of a distance between measured precision position data of the mobile device and the position of another mobile device positioned within the predetermined range, a distance between the precision position data of the mobile device and the work section, and a distance between the precision position data of the mobile device and the danger area is included in a predetermined danger range.

In order to achieve the objectives described above, according to the present disclosure, there is provided a method for identifying a position of a moving object on the basis of the Global Navigation Satellite System (GNSS) and notifying of dangerous accidents, the method including: receiving, by a GNSS position information data receiving unit, current position information data of a mobile device by receiving each GNSS position signal from a plurality of GNSS satellites; receiving, by a Radio Technical Commission for Maritime Services (RTCM) position correction data receiving unit, position correction data of the mobile device in the form of an RTCM stream through a Network Transport of RTCM via Internet Protocol (NTRIP), the position correction data being repeatedly generated by a plurality of reference stations for each GPS satellite; acquiring, by a precision position data acquisition unit, precision position data of the mobile device by applying the position correction data to the received current position information data; and displaying, by a diagram display unit, the acquired precision position data of the mobile device, a position of another mobile device positioned within a predetermined range, a work section, and a danger area on a diagram that is pre-stored and activated on a screen of the mobile device.

In addition, the method may further include, after the acquiring of the precision position data of the mobile device by applying the position correction data to the received current position information data, receiving precision position data acquired from another mobile device in real time.

In addition, the method may further include, after the displaying of the acquired precision position data of the mobile device, the position of another mobile device positioned within the predetermined range, the work section, and the danger area on the diagram that is pre-stored and activated on the screen of the mobile device, measuring a distance between the acquired precision position data of the mobile device and the position of another mobile device positioned within the predetermined range, a distance between the acquired precision position data of the mobile device and the work section, and a distance between the acquired precision position data of the mobile device and the danger area.

In addition, the method may further include, after the measuring of the distance between the acquired precision position data of the mobile device and the position of another mobile device positioned within the predetermined range, the distance between the acquired precision position data of the mobile device and the work section, and the distance between the acquired precision position data of the mobile device and the danger area, generating and outputting danger notification information on the screen of the mobile device when at least one of a distance between measured precision position data of the mobile device and the position of another mobile device positioned within the predetermined range, a distance between the precision position data of the mobile device and the work section, and a distance between the precision position data of the mobile device and the danger area is included in a predetermined danger range.

In the apparatus and method for identifying the position of the moving object on the basis of the GNSS and notifying of dangerous accidents according to the present disclosure, precision position data of the mobile device is acquired by receiving current position information data of the mobile device attached to a drilling apparatus and position correction data of the mobile device repeatedly generated by a plurality of reference stations for each GPS satellite, so that there is an effect of being capable of identifying the position with an error margin within centimeters.

In addition, in the present disclosure, the output danger notification information is generated and displayed on the screen of the mobile device when at least one of the distance between the measured precision position data of the mobile device and another mobile device positioned within the predetermined range, the distance between the precision position data of the mobile device and the work section, and the distance between the precision position data of the mobile device and the danger area is included in the predetermined danger range, so that there are effects that safety is capable of being managed through the exchange of accurate position information between vehicles and vehicles and between vehicles and persons and user's fatigue is capable of being reduced by minimizing unnecessary notifications due to low accuracy. In addition, rockfall/fall accidents are capable of being prevented by warning when the mobile device enters the danger area.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a configuration of a communication system applied to an apparatus for identifying a position of a moving object on the basis of the Global Navigation Satellite System (GNSS) and notifying of dangerous accidents according to the present disclosure;

FIG. 2 is a view illustrating each configuration of mobile devices applied to the apparatus for identifying the position of the moving object on the basis of the GNSS and notifying of the dangerous accidents according to the present disclosure;

FIG. 3 is a view illustrating a configuration of the apparatus for identifying the position of the moving object on the basis of the GNSS and notifying of the dangerous accidents according to the present disclosure; and

FIG. 4 is a flowchart illustrating a sequence of a method for identifying a position of a moving object on the basis of the GNSS and notifying of dangerous accidents according to the present disclosure.

### DETAILED DESCRIPTION OF THE INVENTION

In the present disclosure, various modifications may be made and various exemplary embodiments may be provided, and specific exemplary embodiments will be illustrated in the drawings and described in detail.

However, this is not intended to limit the present disclosure to a particular disclosed form. On the contrary, the present disclosure is to be understood to include all various alternatives, equivalents, and substitutes that may be included within the idea and technical scope of the present disclosure. While describing each drawing, similar reference numerals have been used for similar components.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

The terminology used herein is for the purpose of describing particular exemplary embodiments only and is not intended to be limiting. As used herein, the singular forms are intended to include the plural forms as well, unless the context clearly indicates otherwise. In addition, it will be further understood that the terms “comprise”, “include”, “have”, and so on when used in the present application, specify the presence or absence of stated features, integers, steps, operations, elements, components, and/or combinations of them but do not preclude the possibility of the presence or addition of one or more other features, integers, steps, operations, elements, components, and/or combinations thereof.

Hereinafter, exemplary embodiments of the present disclosure will be described in more detail with reference to the accompanying drawings. Hereinafter, the same reference numerals are used for the same components in the drawings, and duplicate descriptions for the same components are omitted.

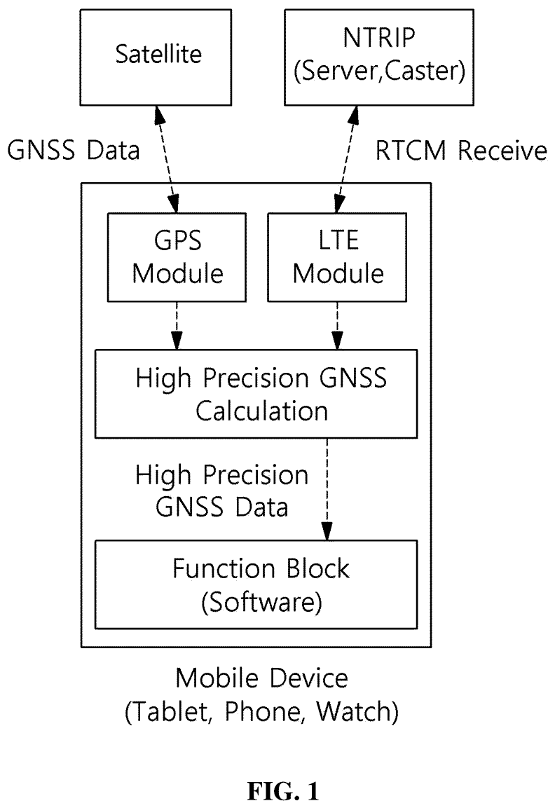

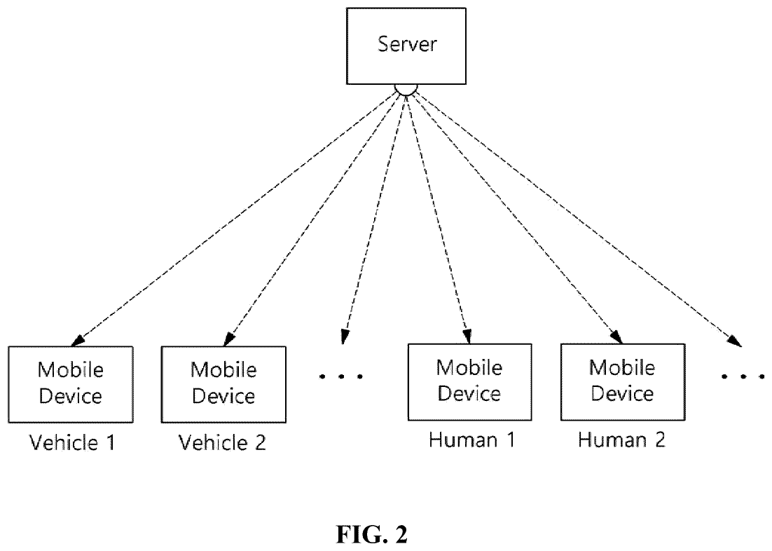

FIG. 1 is a view illustrating a configuration of a communication system applied to an apparatus for identifying a position of a moving object on the basis of the Global Navigation Satellite System (GNSS) and notifying of dangerous accidents according to the present disclosure, and FIG. 2 is a view illustrating each configuration of mobile devices applied to the apparatus for identifying the position of the moving object on the basis of the GNSS and notifying of the dangerous accidents according to the present disclosure.

Referring to FIG. 1, the communication system applied to the apparatus for identifying the position of the moving object on the basis of the GNSS and notifying of the dangerous accidents according to the present disclosure includes a module configured to receive current position information data of a mobile device by receiving each GNSS position signal from a plurality of GNSS satellites, and includes a module configured to receive position correction data of the mobile device in the form of a Radio Technical Commission for Maritime Services (RTCM) stream through a Network Transport of RTCM via Internet Protocol (NTRIP), the position correction data being repeatedly generated by a plurality of reference stations for each GPS satellite.

At this time, the GNSS is a satellite-based positioning system capable of performing high-precision positioning even in a harsh environment by receiving signals transmitted from all satellites such as GPS (USA), GLONASS (Russia), BDS (China), Galileo (Europe), and so on.

In addition, the present disclosure includes a cloud server and at least one mobile device coupled to the cloud server via Internet. At this time, the mobile device may be at least one of a terminal attached to a work vehicle and a terminal carried by a worker. At least one mobile device may be connected to the cloud server via the Internet, and position information data may be transmitted to each other by the cloud service.

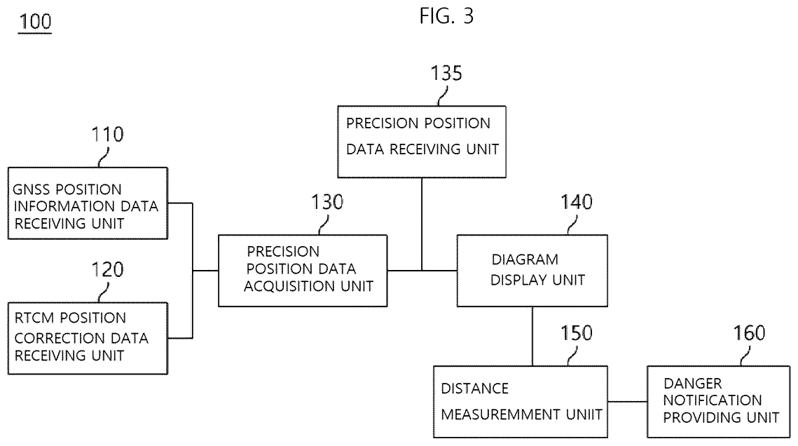

FIG. 3 is a view illustrating a configuration of the apparatus for identifying the position of the moving object on the basis of the GNSS and notifying of the dangerous accidents according to the present disclosure.

Referring to FIG. 3, the apparatus 100 for identifying the position of the moving object on the basis of the GNSS and notifying of the dangerous accidents according to the present disclosure includes a GNSS position information data receiving unit 110, an RTCM position correction data receiving unit 120, a precision position data acquisition unit 130, a precision position data receiving unit 135, a diagram display unit 140, a distance measurement unit 150, and a danger notification providing unit 160.

The GNSS position information data receiving unit 110 is configured to receive current position information data of the mobile device by receiving each GNSS position signal from a plurality of GNSS satellites. At this time, the mobile device may be at least one of a terminal attached to a work vehicle and a terminal carried by a worker.

The RTCM position correction data receiving unit 120 is configured to receive position correction data of the mobile device in the form of the RTCM stream through the NTRIP, the position correction data being repeatedly generated by the plurality of reference stations for each of the GPS satellites.

The precision position data acquisition unit 130 is configured to acquire precision position data of the mobile device by applying the position correction data to the received current position information data.

The precision position data receiving unit 135 is configured to receive precision position data acquired from another mobile device in real time. At this time, as described above, another mobile device is capable of acquiring precision position data on the basis of current position information data of a mobile device attached to a drilling apparatus and position correction data of the mobile device by receiving each GNSS position signal from the plurality of GNSS satellites, the position correction data being repeatedly generated by the plurality of reference stations for each of the GPS satellites.

The diagram display unit 140 is configured to display acquired precision position data of the mobile device, a position of another mobile device positioned within a predetermined range, a path, a work section, and a danger area on a diagram (such as topographic diagram, a cadastral diagram, a design diagram, and so on) that is pre-stored and activated on a screen of the mobile device.

The distance measurement unit 150 is configured to measure a distance between the acquired precision position data of the mobile device and the position of another mobile device positioned within the predetermined range, a distance between the acquired precision position data of the mobile device and the work section, and a distance between the acquired precision position data of the mobile device and the danger area.

That is, the distance measurement unit 150 is configured to measure a distance between work vehicles, a distance between a work vehicle and a worker, a distance between a work vehicle and the danger area, a distance between workers, and a distance between a worker and the danger area on the basis of the precision position data, a velocity vector, and a displacement vector.

The danger notification providing unit 160 is configured to generate and output danger notification information on the screen of the mobile device when at least one of the distance between measured precision position data of the mobile device and the position of another mobile device positioned within the predetermined range, the distance between the precision position data of the mobile device and the work section, and the distance between the precision position data of the mobile device and the danger area is included in a predetermined danger range.

The danger notification providing unit 160 is configured to output an alarm sound and the danger notification information including information and a distance of an object included within the predetermined danger range on the screen of the mobile device.

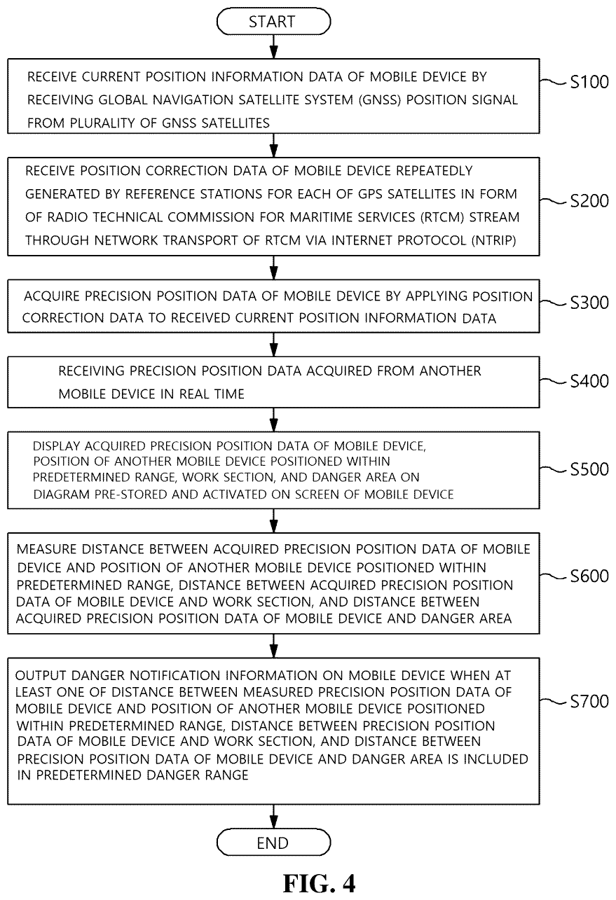

FIG. 4 is a flowchart illustrating a sequence of a method for identifying a position of a moving object on the basis of the GNSS and notifying of dangerous accidents according to the present disclosure.

Referring to FIG. 4, the method for identifying the position of the moving object on the basis of the GNSS and notifying of the dangerous accidents according to the present disclosure uses the apparatus for identifying the position of the moving object on the basis of the GNSS and notifying of the dangerous accidents described above, and duplicate descriptions will be omitted.

First, current position information data of a mobile device is received by receiving each GNSS position signal from a plurality of GNSS satellites (S100). At this time, the mobile device may be at least one of a terminal attached to a work vehicle and a terminal carried by a worker.

Next, position correction data of the mobile device is received in the form of an RTCM stream through an NTRIP, the position correction data being repeatedly generated by the plurality of reference stations for each of the GPS satellites (S200).

Next, precise position data of the mobile device is acquired by applying the position correction data to the received current position information data (S300).

Next, precise position data acquired from another mobile device is received in real time (S400). At this time, as described above, another mobile device is capable of acquiring precision position data on the basis of current position information data of a mobile device attached to a drilling apparatus and position correction data of the mobile device by receiving each GNSS position signal from the plurality of GNSS satellites, the position correction data being repeatedly generated by the plurality of reference stations for each of the GPS satellites.

Next, the acquired precision position data of the mobile device, a position of another mobile device positioned within a predetermined range, a path, a work section, and a danger area is displayed on a diagram (such as topographic diagram, a cadastral diagram, a design diagram, and so on) that is pre-stored and activated on a screen of the mobile device (S500).

Next, a distance between the acquired precision position data of the mobile device and the position of another mobile device positioned within the predetermined range, a distance between the acquired precision position data of the mobile device and the work section, and a distance between the acquired precision position data of the mobile device and the danger area are measured (S600).

In the S600 process, a distance between work vehicles, a distance between a work vehicle and a worker, a distance between a work vehicle and the danger area, a distance between workers, and a distance between a worker and the danger area are measured on the basis of the precision position data.

Next, danger notification information is displayed on the screen of the mobile device when at least one of the distance between measured precision position data of the mobile device and the position of another mobile device positioned within the predetermined range, the distance between the precision position data of the mobile device and the work section, and the distance between the precision position data of the mobile device and the danger area is included in a predetermined danger range (S700).

In the S700 process, an alarm sound and the danger notification information including information and a distance of an object included within the predetermined danger range is output on the screen of the mobile device.

As described above, the functional operation and the embodiments related to the present subject matter, which are described in the present specification, may be implemented in a digital electronic circuit or computer software, firmware, hardware, or a combination of one or more thereof, including the structures and structural equivalents thereof, which are disclosed herein.

The embodiments of the subject matter described herein may be implemented as one or more computer program products, i.e., one or more modules related to computer program instructions encoded on a tangible program medium for execution by or for controlling the operation of a data processing device. The tangible program medium may be a radio wave signal or a computer-readable medium. The radio wave signal is a signal generated to encode information to be transmitted to an appropriate receiver device for execution by a computer, that is, for example, an artificially generated signal such as a machine-generated electrical, optical, or electromagnetic signal. The computer-readable medium may be a machine-readable storage device, a machine-readable storage substrate, a memory device, a combination of materials that affect a machine-readable radio wave signal, or a combination of one or more thereof.

The present description presents the best mode of the present disclosure, and provides examples for describing the present disclosure and for enabling those skilled in the art to make and use the present disclosure. The specification written in this way is not intended to limit the present disclosure to the specific terms presented.

Accordingly, although the present disclosure has been described in detail with reference to the above-described examples, those skilled in the art can make modifications, changes, and deformation to the present examples without departing from the scope of the present disclosure. In short, in order to achieve the intended effect of the present disclosure, it is not necessary to separately include all the functional blocks shown in the drawings or follow all the orders shown in the drawings. It should be noted that even though all the functional blocks are separately included or all the orders shown in the drawings are followed as they are shown, the corresponding functional blocks and orders may fall within the technical scope of the present invention described in the claims.

What is claimed is:

1. An apparatus for identifying a position of a moving object on the basis of the Global Navigation Satellite System (GNSS) and notifying of dangerous accidents, the apparatus comprising:
a GNSS position information data receiving unit configured to receive current position information data of a mobile device by receiving each GNSS position signal from a plurality of GNSS satellites;
a Radio Technical Commission for Maritime Services (RTCM) position correction data receiving unit configured to receive position correction data of the mobile device in the form of an RTCM stream through a Network Transport of RTCM via Internet Protocol (NTRIP), the position correction data being repeatedly generated by a plurality of reference stations for each GPS satellite;
a precision position data acquisition unit configured to acquire precision position data of the mobile device by applying the position correction data to the received current position information data; and
a diagram display unit configured to display the acquired precision position data of the mobile device, a position of another mobile device positioned within a predetermined range, a work section, and a danger area on a diagram that is pre-stored and activated on a screen of the mobile device.

2. The apparatus of claim 1, wherein the mobile device may be at least one of a terminal attached to a work vehicle and a terminal carried by a worker.

3. The apparatus of claim 1, further comprising a precision position data receiving unit configured to receive precision position data acquired from another mobile device in real time.

4. The apparatus of claim 1, further comprising a distance measurement unit configured to measure a distance between the acquired precision position data of the mobile device and the position of another mobile device positioned within the predetermined range, a distance between the acquired precision position data of the mobile device and the work section, and a distance between the acquired precision position data of the mobile device and the danger area.

5. The apparatus of claim 1, further comprising a danger notification providing unit configured to generate and output danger notification information on the screen of the mobile device when at least one of a distance between measured precision position data of the mobile device and the position of another mobile device positioned within the predetermined range, a distance between the precision position data of the mobile device and the work section, and a distance between the precision position data of the mobile device and the danger area is included in a predetermined danger range.

6. A method for identifying a position of a moving object on the basis of the Global Navigation Satellite System (GNSS) and notifying of dangerous accidents, the method comprising:
receiving, by a GNSS position information data receiving unit, current position information data of a mobile device by receiving each GNSS position signal from a plurality of GNSS satellites;
receiving, by a Radio Technical Commission for Maritime Services (RTCM) position correction data receiving unit, position correction data of the mobile device in the form of an RTCM stream through a Network Transport of RTCM via Internet Protocol (NTRIP), the position correction data being repeatedly generated by a plurality of reference stations for each GPS satellite;
acquiring, by a precision position data acquisition unit, precision position data of the mobile device by applying the position correction data to the received current position information data; and
displaying, by a diagram display unit, the acquired precision position data of the mobile device, a position of another mobile device positioned within a predetermined range, a work section, and a danger area on a diagram that is pre-stored and activated on a screen of the mobile device.

7. The method of claim 6, further comprising:
after the acquiring of the precision position data of the mobile device by applying the position correction data to the received current position information data,
receiving precision position data acquired from another mobile device in real time.

8. The method of claim 6, further comprising:
after the displaying of the acquired precision position data of the mobile device, the position of another mobile device positioned within the predetermined range, the work section, and the danger area on the diagram that is pre-stored and activated on the screen of the mobile device,
measuring a distance between the acquired precision position data of the mobile device and the position of another mobile device positioned within the predetermined range, a distance between the acquired precision position data of the mobile device and the work section, and a distance between the acquired precision position data of the mobile device and the danger area.

9. The method of claim 8, further comprising:
after the measuring of the distance between the acquired precision position data of the mobile device and the position of another mobile device positioned within the predetermined range, the distance between the acquired precision position data of the mobile device and the work section, and the distance between the acquired precision position data of the mobile device and the danger area,
generating and outputting danger notification information on the screen of the mobile device when at least one of a distance between measured precision position data of the mobile device and the position of another mobile device positioned within the predetermined range, a distance between the precision position data of the mobile device and the work section, and a distance between the precision position data of the mobile device and the danger area is included in a predetermined danger range.
